(19) United States
(12) Patent Application Publication
(10) Pub. No.: US 2024/0097154 A1
(43) Pub. Date: Mar. 21, 2024

(54) SEALANT RESIN COMPOSITION FOR FLEXIBLE GRAPHITE PLATE IMPREGNATION

(71) Applicant: Godfrey & Wing, LLC, Aurora, OH (US)

(72) Inventors: Xiaoming Wu, Aurora, OH (US); Thomas Steele, Aurora, OH (US)

(73) Assignee: Godfrey & Wing, LLC, Aurora, OH (US)

(21) Appl. No.: 18/196,488

(22) Filed: May 12, 2023

Related U.S. Application Data
(60) Provisional application No. 63/405,421, filed on Sep. 10, 2022.

(51) Int. Cl. H01M 8/0284

(52) U.S. Cl. CPC H01M 8/0284

(57) ABSTRACT

A sealant configured to saturate and seal a graphite plate, such as a type of graphite plate that may be used in a hydrogen (H₂) fuel cell, wherein the sealant may be one or more, or a mixture, of ethoxylated monomers. In some embodiments herein the sealant does not have an acid or a surfactant. Also disclosed is a graphite sheet impregnated with a sealant.

### CROSS-REFERENCE TO RELATED APPLICATIONS

This application claims priority to U.S. Provisional application No. 63/405,421 entitled PROPRIETARY CURE MODULE AND METHOD FOR IMPREGNATING GRAPHITE and filed on Sep. 10, 2022, the contents of which that are not inconsistent with this disclosure are incorporated herein by reference.

### BACKGROUND

Graphite bipolar plates, which can be used in hydrogen fuel cells, are manufactured by press-molding flexible graphite under high pressure. These graphite bipolar plates are porous, leading to high permeability, leakage, and low mechanical strength. Impregnation of sealant into graphite plates is an effective way to minimize the permeability, improve the mechanical strength of the plates, while preserving the electrical and thermal cooling properties required in fuel cell applications. Using such a process, the graphite part to be sealed is usually subjected to a dry vacuum to evacuate the void volume of air from the part. The part is then immersed in liquid sealant while under vacuum for a certain period, and then subjected to an increase in pressure of about 1 Bar to 5.5 Bars so that the pressure helps to force the liquid sealant into the voided porosity of the graphite plate. Excess sealant on the surface of the graphite plate is then removed, usually by washing it off with water which may contain a surfactant or solvent. The washed, impregnated plate is then treated to polymerize the monomers in the graphite porosity into a cured, solid sealant.

Hence the graphite plate's mechanical strength is enhanced, and through-plate leakage paths are largely sealed. Desirable properties for the liquid sealant include (1) sufficiently low viscosity to facilitate penetration of the part, and (2) reducing the curing time required to polymerize the liquid sealant inside of the graphite.

### SUMMARY

In this disclosure, liquid sealant include acrylic monomers and/or methacrylic monomers. These olefinic monomers of sealants undergo polymerization and convert into a solid polymer after impregnation in a graphite plate to fill the voids inside the graphite plate. Monomer polymerization can be induced chemically with a radical initiator that produces free radicals and causes the monomer to crosslink (also called cure) when heated. Monomer polymerization can be also physically induced through radiation such as an electronic beam (E-beam). The sealants can comprise one monomer but could also comprise multiple (two or more) monomers to achieve the desired properties related to graphite plate process and performance. These properties include for the liquid sealant one or more of hydrophilicity, viscosity, density, curing reactivity, phase change shrinkage, as well as, for the cured sealant, thermal mechanical strength, surface tension, and chemical resistance.

In one embodiment, the thermal-cure sealant generally has two components that are a monomer composition and a free radical initiator. Upon sufficient energy being introduced to the part by heating, the monomers polymerize (also called cure).

In one embodiment, the sealant resin composition consists of only monomers. Upon the exposure to high energy E-beam radiation, the sealant monomers inside the impregnated graphite will undergo free radical polymerization and cure.

During vacuum/pressure impregnation, liquid sealant wicks and fills the graphite porosity. The application of high pressure after vacuum application facilitates the liquid-sealant filling process by forcing liquid sealant into the substrate's void volume.

It is preferred that the impregnated part (such as a graphite plate) after sealant impregnation has a clean outer surface with the liquid sealant on the outer surface of the part removed. Prior to the cure of the part impregnated with the liquid sealant, the graphite plates are washed with water, which can include a surfactant or solvents, to remove excess sealant from the outer surface of the part. It is therefore preferred that for good liquid sealant processability the sealant has balanced hydrophilicity (so the excess liquid sealant can be readily washed off the surface of the part with water) and a relatively low viscosity (so the liquid sealant can quickly fill the pores of the part). One or more monomers, such as ether, ketone, carboxylate, carboxylic acid, and alcohol help create a sealant with higher hydrophilicity while higher molecular weight monomers enhance sealant viscosity. Consideration of monomer properties and the proper combination of monomers attain the desired sealant characteristics.

### DETAILED DESCRIPTION

The description herein is to identify embodiments of the sealant resin and impregnated graphite parts and not to limit the scope of the claims.

### Sealant

In one embodiment, the liquid sealant includes one or more dimethacrylate or diacrylate monomers, which are preferably one or more ethoxylated dimethacrylate or ethoxylated diacrylate monomers. One preferred sealant formulation includes 70%-95% of triethylene glycol dimethacrylate. Another preferred sealant formulation includes 80%-100%, or 85-100%, or 90-100% of triethylene glycol dimethacrylate. One or more of the sealant's hydrophilicity, viscosity, and other desired properties can be attained by adjusting the sealant compositions by adding other monomers. The nonfunctionalized alkyl, aryl acrylate, and/or methacrylate lowers the sealant's hydrophilicity, while constituents such as alcohol- or acid-containing (such as carboxylic acid) acrylates or methacrylates to enhance hydrophilicity. The addition of these constituents may also modify one or more of the thermal mechanical strength, surface tension, and chemical resistance of the cured sealant. The chemical resistance and mechanical properties are also modified by a cross-linker, which is generally a molecule possessing more than two arylate/methacrylate constituents (but can be any suitable cross-linker), in the sealant formulation. The liquid sealant viscosity is preferably in the range of 8-20 cps at 22° C. The liquid sealant according to this disclosure in a graphite plate cures in about 10 minutes to about 45 minutes when immersed in water at a temperature of 70° C. to 90° C. or about 80° C. to about 95° C. Known sealants, on the other hand, take hours to cure under the same conditions.

Multiple-functional [meth]acrylic monomers that may be used in a sealant according to this disclosure include, but are not limited to, one or more of the following: trimethylolpropane ethoxylate triacrylates/trimethacrylates encompassing a range of molecular weights due to the number of moles of ethylene oxide (EO). These monomers in the composition will assist in the sealant's fast cure time, greater hardness, and lower shrinkage.

The thermal curing of the liquid sealant with a radical initiator (or simply, “initiator”) impregnated in graphite is normally executed in a water bath or bake oven (i.e., a hot air cure). E-beam exposure may also be used to cure the liquid sealant if no initiator is utilized, and the liquid sealant is only a combination of monomers configured to cure without an initiator.

Suitable radical initiators (or initiators), if used, may include azo-type and/or peroxide-type initiators that are typically used in polymerization reactions, wherein an azo molecule is most preferred. Some possible initiators are shown below:

TABLE

| | Common | | Max deg. C | Deg. C | 1 Hr Half | % Active |
|---|---|---|---|---|---|---|
| Name | Name | Type | Storage | *SADT | Life Temp (C) | Oxygen |
| t-butyl peroxy neodecanoate | Luperox-10M75 | t-alkyl peroxy ester | −10 | 27 | 66 | 4.9 |
| Dilauroyl peroxide | Luperox-LP | diacyl peroxide | 30 | 50 | 79 | 4.0 |
| 2,2′-azo diisobutylnitrile | AZDN; Vazo-64 | Azo | 25 | 50 | 82 | 0.0 |
| 2,2′-azodi-(2-methylbutyronitrile) | Vazo-67 | Azo | 25 | 45 | 84 | 0.0 |
| t-amyl peroxy 2-ethylhexanoate | Luperox-575 | t-alkyl peroxy ester | 5 | 35 | 91 | 6.7 |
| Dibenzoyl peroxide | BP | diacyl peroxide | 30 | 50 | 91 | 2.7 |
| Dicumyl peroxide | Di-CUP | di t-alkyl peroxide | 30 | 80 | 132 | 5.9 |
| t-butyl hydroperoxide | TBH-70X | alkyl hydroperoxide | 30 | 90 | 185 | 12.5 |

*SADT = Self Accelerating Decomposition Temperature

At an elevated temperature, the initiator initiates polymerization of the acrylic monomer(s) in the liquid sealant. To help provide the sealant with a large processing window (meaning that it does not cure before the final curing step) and safe handling for graphite plate impregnation, the sealant should remain inert (i.e., in an uncured, liquid state) at room temperature processing steps prior to curing at temperature of about 80°-95° C., or about 85°-90° C. The initiator, such as preferably Vazo 64 from Chemours, is used in the sealant formulation with loading of 0.15-0.35% of total sealant weight.

The olefinic monomers of a sealant according to this disclosure include but are not limited to one or more of the following: di/tri-functional [meth]acrylic monomers that provide multiple reactive sites for extended cross-linking to build a robust polymer network. Examples may include one or more of: polyethylene glycol diacrylates/dimethacrylates, triethylene glycol diacrylate/dimethacrylate, diethylene glycol diacrylate/dimethacrylate, polypropylene glycol diacrylates/dimethacrylates, tripropylene glycol diacrylate/dimethacrylate, dipropylene glycol diacrylate/dimethacrylate, butylene glycol diacrylate/dimethacrylate, butanediol diacrylate/dimethacrylate, hexanediol diacrylate/dimethacrylate, dodecandiol diacrylate/dimethacrylate, trimethylolpropane tri[meth]acrylate, trimethylolpropane tri[meth]acrylate (ethoxylated).

The difunctional [meth]arylated monomer could also include bisphenol-A glycidyl based monomers in which hydroxy functionality could modify the hydrophilicity and improve polymer in mechanical properties in the graphite porosity.

Mono-functional [meth]acrylic monomers that may be used in a sealant according to this disclosure include but are not limited to monomers that can further incorporate functionality designed to modify the physical properties such as one or more of greater hydrophilicity, flexibility, and better adhesion of the final cured sealant. Examples may include one or more of: [meth]acrylic acid, 2-carboxyethyl [meth]acrylate, hydroxy propyl methacrylate, lauryl [meth]acrylate, stearyl [meth]acrylate, polypropylene glycol [meth]acrylates.

A sealant according to this disclosure need not, and preferably does not include a surfactant or an acid, although it may include a 4% acidic (such as acrylic acid) adhesion promoter, but no adhesion promoter is required.

### Example 1

In a 200-mL beaker, 96.0 g of triethylene glycol dimethacrylate was weighed with 4.0 g of acrylic acid. To the monomer mixture, 0.3 g of Vazo 64 powder was added. The mixture was agitated until the initiator powder was completely dissolved. The resulting liquid sealant density was 1.072 g/cm3 and its viscosity was 9.5 cps. The gel time, which is measured by heating 1.0 g of sealant in a test tube at 90° C. in a heat block, was 2:35 min:sec. The curing shrinkage, determined by a comparison of the liquid sealant and solid, cured sealant weight/volume, was 12.55%. The cured sealant hardness (Shore D) was 85.

### Example 2

In a 200-mL beaker, 90.0 g of triethylene glycol dimethacrylate was mixed with 10.0 g of trimethylol propane ethoxylate (EO15, 15 ethylene oxide units) triacrylate. To this monomer mixture, 0.3 g of Vazo 64 powder was added and the mixture was agitated until the initiator was dissolved. The liquid sealant density was 1.075 g/cm3 and the viscosity was 12.0 cps. The liquid sealant gel time measured with 1.0 g of sealant in a test tube at 90 C in a heat block was 2:45 min:sec. Upon curing, the sealant volume shrinkage was about 12.3%. The cured sealant hardness (Shore D) was 90.

### Example 3

In a 200 mL beaker, 76.0 g of triethylene glycol dimethacrylate was mixed with 1.0 g of hydroxypropyl methacrylate, 4 g of a proprietary unsaturated polyester resin (UPR), and 10 g of trimethylol propane ethoxylate (EO3) triacrylate. To this monomer mixture, 0.3 g of Vazo 64 powder was added and the mixture was agitated until the initiator was dissolved. The liquid sealant density was 1.088 g/cm3 and the viscosity was 15.0 cps. The liquid sealant gel time measured with 1.0 g of sealant in a test tube at 90 C in a heat block was 3:05 min:sec. The cured sealant hardness (Shore D) was 95.

### Example 4

In a 200 mL beaker, 70.0 g of triethylene glycol dimethacrylate was mixed with 0.0 g of hydroxypropyl methacrylate, 10 g of PEG600 dimethacrylate, and 10 g of trimethylol propane trimethacrylate. To this monomer mixture, 0.3 g of Vazo 64 powder was added and the mixture was agitated until the initiator was dissolved. The liquid sealant density was 1.080 g/cm3 and the viscosity was 17.0 cps. The liquid sealant gel time measured with 1.0 g of sealant in a test tube at 90 C in a heat block was 2:55 min:sec. The cured sealant hardness (Shore D) was 95.

### Example 5

In a 200 mL beaker, 60.0 g of dodecane dimethacrylate was mixed with 20.0 g of hydroxypropyl methacrylate, 10 g of polypropylene glycol-400 dimethacrylate, and 10 g of diethylene glycol dimethacrylate. To this monomer mixture, 0.3 g of Vazo 64 powder was added and the mixture was agitated until the initiator was dissolved. The liquid sealant density was 0.98 g/cm3 and the viscosity was 8.0 cps. The liquid sealant gel time measured with 1.0 g of sealant in a test tube at 90 C in a heat block was 3:15 min:sec. The cured sealant hardness (Shore D) was 95.

### Example of Using the Sealant

Graphite plates are placed into a chamber and a vacuum of 6.5 mBar, or an amount from 0-27 mBar, is drawn inside the chamber and on the graphite plates. Then sealant is drawn into the chamber using the vacuum to draw it in although the sealant can be placed in the chamber using any suitable method. After the graphite plates are covered (immersed) in the liquid sealant the chamber is subjected to an over pressure of approximately 5.5 Bar (3.0 Bar to 8.5 Bar is a typical range). The hydraulic effect of the overpressure helps to push the liquid sealant into the porosity of the graphite plates.

### Example of Measuring the Viscosity of the Liquid Sealant

A Zahn viscosity cup method is used to measure the viscosity of the liquid sealant. The Zahn cup is completely lowered below the sealant surface in a beaker. The viscosity cup is lifted out of the sealant and a timer is started. The time is recorded when the sealant is completely drained from the viscosity cup. The current viscosity specification is between 20 to 30 seconds. Since viscosity affects sealant uptake and void fill, higher viscosity resins may not function properly.

While viscosity can be measured utilizing a Zahn cup, it can also be measured using a Brookfield viscometer, which will provide a viscosity measure in centipoise (cps). The liquid sealant viscosity is 8-20 cps at 22° C. when measured on the Brookfield viscometer equipped with 00 spindle at 6 RPM.

### Example of Gel Time of the Liquid Sealant

Gel time test is used to estimate whether the liquid sealant is curing within the expected curing profile. If the results are out of the specification target, the concentration of the activator would be adjusted. A metal wire, culture test tube, heat block (or hot water bath), and timer are required to perform the gel test. The metal wire is placed into the culture tube so that a portion remains outside of the tube and is long enough to hold. A culture tube is then filled with sealant. The heat block is preferably about 90° C.±1° C. and the tube with sealant is placed into a well of heat block that contains small amount of heating oil. The oil level in the well should be higher than or equal to the sealant level in the tube in order to thoroughly heat the sealant. After about 90 seconds the wire is lifted. If the entire tube lifts with the wire, the sealant has cured. If the tube does not lift the sealant has not cured and the wire is placed back into the tube. Then an operator can check every 3 seconds (by lifting the wire) until the sealant has cured and note the time it took for the sealant to cure. The current specification target for gel time of the sealant is 1.6 to 2.4 minutes, although it could be any suitable time.

### Example of Impregnation and Curing of the Graphite Plate

In an exemplary impregnation processing, graphite plates are vacuumed to evacuate the air from the micro voids at 6.5 mBar before covered (immersed) in liquid sealant. Vacuum of 6.5 mBar, is drawn on the graphite plates while they are immersed in the sealant. The graphite plates are then subjected to an over pressure of approximately 5.5 Bar (3.0 Bar to 8.5 Bar is a typical range). The hydraulic effect of the overpressure helps to push the liquid sealant to fill at least most of the porosity of the graphite plates.

When the graphite parts are sufficiently impregnated with sealant, the pressure is removed so it returns to atmospheric. Water is used to rinse excess sealant off the surfaces of the graphite plates.

The thermal cure sealant is configured to cure in 10 minutes or less, or less than 45 minutes, after being impregnated in a graphite sheet and the graphite sheet is positioned in pressurized and heated water, preferably heated to 70°-120° C. The pressure of the water need only be sufficient to essentially prevent steam from forming. Alternatively, any suitable heating process can be used, such curing with water steam.

Exemplary parameters for a process to seal graphite plates using a sealant of this disclosure follow:

| | Exemplary Value |
|---|---|
| Vacuum Impregnation | for Graphite Parts |
| Vacuum Level (mBar) | 1-6.5 mBar |
| Dry Vacuum Hold (seconds) | 180-900 |
| Wet Vacuum Hold (seconds) | 180-900 |
| Pressure Level (BAR) | 5.5 |
| Pressure Hold Time (seconds) | 180-900 |
| Liquid Sealant Temperature ° C. | 18-22 |
| Overall Cycle (seconds) | 600-900 |
| Rinse/Wash Cycles | |
| Temperature ° C. | 20-25 |
| Cycle Time (seconds) | Sub 600 |
| Cure | |
| Water Temperature ° C. | 90 |

Physical property evaluation of cured sealant and impregnated parts following curing may include any number of thermal-mechanical techniques. These may include but are not limited to differential scanning calorimetry (DSC), dynamic mechanical analysis (DMA), and thermo-gravimetric analysis (TGA). DSC is typically employed to measure glass transition temperature (Tg) and/or the curing profile and degree of cure. DMA may also be used to measure Tg by employing a three-point bend test. TGA is often used to evaluate decomposition characteristics as the cured sample is taken through a temperature ramp from ambient to near 500° C.

### Parameters of the Sealed and Cured Graphite Bipolar Plate Glass Transition Temperature (Tg)

Glass transition temperature (Tg) is the temperature at which the polymer structure transitions from glassy to rubbery. This temperature is evaluated to ensure the mechanical stability of sealant-impregnated graphite at fuel cell operating conditions. A three-point bend test on a dynamic mechanical analyzer (DMA) was performed to determine the Tg of impregnated graphite samples. The procedure is based on ASTM D7028 and ISO 6721 guidelines, but any suitable procedure may be utilized.

A strain controlled module was used with a heating rate of 2° C./min. to increase the temperature from 25° C. to 210° C. According to ASTM D7028, Tan 6 peak is defined as Tg in the presented results. The target to ensure materials are stable at fuel cell operating conditions is Tg>120° C.

### Extractables on the Cured Graphite Plates

If there are uncured monomers they could affect the performance of the fuel cell either through permeability, heat transfer, or other properties. Extraction of uncured monomers with solvent(s) can be used to determine the completeness of the cure. Refer to ISO 1407:2011 for additional guidance. Recommendation is to break a number of graphite plates into small pieces to increase surface area for solvent penetration and extraction.

Extractables are measured by the mass loss and gas chromatography-mass spectrometry (GC-MS) or gas chromatography-flame ionization detection (GC-FID) of the solvent/uncured monomer mixture. First, the sealant is cured by monomers' polymerization in the thin sheets. Thin sheets of graphite (the thickness can vary and can range from 0.2 mm-0.8 mm, or be of any suitable thickness) are first vacuum impregnated with sealant. The impregnated sheets are then thermally cured at the prescribed time and temperature. Once cured and cooled to room temperature, the graphite plates are soaked in a solvent. This soak time can vary and can be any suitable time. Upon completion of the soak, the solvent is analyzed for any uncured monomer. as thicker samples may be more difficult to extract using solvents. After the sheets are completely cured an appropriate solvent such as mixture of dichloromethane (DCM) and methanol (MeOH), DCM/MeOH (90:10) should be used to soak the fully cured graphite sheets impregnated with the sealant. The graphite sealant sheet soaking takes about 2 hours at room temperature. Then the graphite sealant sheets are dried after soaking and measure the final mass of each sheet. The percentage of extractables may be calculated from the difference in mass. Subsequently, GC-MS or GC-FID can be performed on the remaining solvent to determine leachable monomers and contaminants. The purpose is to detect any uncured monomer in the graphite sheet as these will be extracted in the solvent.

### Void Fill Calculation

Void fill percentage of the impregnated plates should be calculated using the following formula: % void fill=(post weight−preweight)/resin density+plate volume−(preweight/graphite density).

Pre-weight is the weight of the graphite plate before impregnation. Post weight is the weight of the graphite plate after impregnation. Plate volume is measured by a water displacement method. The impregnated plate is submerged in a deionized water tank and the volume of the displaced water is measured using a graduated cylinder. Any suitable method, however, may be used.

### Typical Material Targets for a Liquid Sealant and Finished Graphite Plate According to this Disclosure

| Property | Target |
|---|---|
| Extractables from cured sealant in | <10 Wt. % of the weight of cured |
| graphite sheet | sealant in graphite sheet |
| Cure profile (Time/Temp) | <100 min, <100° C. |
| Glass transition temperature (3-pt | Tg >120° C. (Based on |
| bend) | maximum FC temperature) |
| Extractables on finished | <3 Wt. % of total weight of |
| graphite plate | finished graphite plate |
| Degree of cure (DSC) in plate form | No exotherm under 200° C. (avoid |
| | temperatures past degradation |
| | temperature) |
| Void fill of the finished | >95% |
| graphite sheet | |
| Gas tightness of the finished graphite | no leaks |
| sheet | |

Some non-limiting examples of this disclosure are as follows:

Example 1: A sealant configured to saturate and seal a graphite plate for use in a hydrogen (H₂) fuel cell, wherein the sealant comprises one or more, or a mixture, of ethoxylated [meth]acrylate monomers.

Example 2: The sealant of examples 1, wherein the sealant comprises 70-95% triethylene glycol dimethacrylate monomer by weight.

Example 3: The sealant of any one of examples 1-2, wherein the sealant comprises a [meth]acrylate-based monomer.

Example 4: The sealant of any one of examples 1-3 that includes a trifunctional monomer.

Example 5: The sealant of any one of examples 1-4, wherein the sealant has a viscosity at 22° C. of 8-20 centipoise (cP).

Example 6: The sealant of any one of examples 1-5, wherein the sealant has a viscosity at 25° C. of 20-30 seconds based on S90 No. 1 Zahn cup measurement.

Example 7: The sealant of any one of examples 1-6, wherein the sealant is configured to be washed with water to remove it from the graphite plate surface prior to curing.

Example 8: The sealant of any one of examples 1-7 that has sufficient cured hardness up to 90 Shore D to provide the necessary rigidity of the plate during normal fuel cell device operation.

Example 9: The sealant of any one of examples 1-8 that exhibits necessary cured chemical resistance required to avoid degradation due to interaction with electrolyte and other chemicals during normal fuel cell device operation.

Example 10: The sealant of any one of examples 1-9, wherein the curing completion is determined by a solvent extraction test.

Example 11: The sealant of any one of examples 1-3, wherein the extractables in a cured graphite plate impregnated with the sealant are <3% by weight.

Example 12: The sealant of any one of examples 1-11 that can be cured by exposure to E-beam radiation.

Some further non-limiting examples of this disclosure are as follows:

Example 1: A thermal cure sealant configured to saturate and seal a graphite plate for use in a hydrogen (H₂) fuel cell, wherein the sealant comprises one or more ethoxylated [meth]acrylate monomers.

Example 2: The sealant of example 1, wherein the sealant comprises 70-95% triethylene glycol dimethacrylate monomer by weight.

Example 3: The sealant of any one of examples 1-2, wherein the sealant comprises a [meth]acrylate-based monomer.

Example 4: The sealant of any one of examples 1-3 that includes a trifunctional monomer.

Example 5: The sealant of any one of examples 1-4 that further comprises a radical initiator.

Example 6: The sealant of example 5, wherein the radical initiator is VAZO 64.

Example 7: The sealant of example 6, wherein the sealant contains a radical initiator, which may be VAZO 64, in the range of 0.15-0.35% by weight

Example 8: The sealant of any one of examples 1-7, wherein the sealant has a viscosity at 22° C. of 8-20 centipoise (cP).

Example 9: The sealant of any one of examples 1-8, wherein the sealant has a viscosity at 25° C. of 20-30 seconds based on S90 No. 1 Zahn cup measurement.

Example 10: The sealant of any one of examples 1-9, wherein the sealant is configured to be washed with water to remove it from the graphite plate surface prior to curing.

Example 11: The sealant of any one of examples 1-10 that has sufficient cured hardness up to 90 Shore D to provide the necessary rigidity of the plate during normal fuel cell device operation.

Example 12: The sealant of any one of examples 1-11 that exhibits necessary cured chemical resistance required to avoid degradation due to interaction with electrolyte and other chemicals during normal fuel cell device operation.

Example 13: The sealant of any one of examples 1-12 that is configured to cure in 10 minutes or less, or less than 45 minutes, after being impregnated in a graphite sheet and the graphite sheet is immersed in water at 80° C.-95° C.

Example 14: The sealant of any one of examples 1-13, wherein the cure time is determined by a solvent extraction test.

Example 15: The sealant of any one of examples 1-14, wherein the extractables in a cured graphite plate impregnated with the sealant are <10% by weight.

Example 16: The sealant of any one of examples 1-12 or 14-15 that has a cure profile of <100 minutes at a temperature of <100° C. in a heat cure system.

Example 17: The sealant of example 16, wherein the cure profile is generated at atmospheric pressure.

Example 18: The sealant of any one of examples 1-17 that has a gel time in a 90° C. heat block from 2-6 min.

Example 19: The sealant of any one of examples 1-18 that has an activated resin stability of no curing up to 1 week at 40° C.

Example 20: The sealant of any one of examples 1-19 that does not include a surfactant.

Example 21: The sealant of any one of examples 1-20 that provides a flexural strength of cured impregnated graphite plates at 95° C. of a <30% drop from RT strength.

Example 22: The sealant of any one of examples 1-21 that does not include an acid.

Some further non-limiting examples of this disclosure are as follows:

Example 1: A method of making a graphite plate impregnated with a thermal cure sealant that comprises the steps of impregnating the graphite plate with sealant, and then increasing the temperature and increasing the pressure.

Example 2: The method of example 1 wherein the sealant is cured in the graphite sheet at a temperature of 100° C.-120° C. or higher.

Example 3: The method of example 1 wherein the sealant is cured when immersed in water at 90° C.-100° C., or at 80° C.-95° C.

Example 4: The method of any one of examples 1-3 that further includes the step of measuring extractables by a mass loss of the cured impregnated graphite to extraction solvent.

Example 5: The method of example 4, wherein the extractables in the solvent can be further measured by one or both of the GC-MS and GC-FID.

Example 6: The method of any one of examples 1-5 that further includes the step of curing the graphite plate after being impregnated with the sealant.

Example 7: The method of any one of examples 1-5, wherein the cured graphite plate is soaked in a solvent, and the solvent is DCM/MeOH.

Example 8: The method of example 7, wherein the solvent is 90% DCM and 10% MeOH.

Example 9: The method of any one of examples 7-8, wherein the soaking step lasts about 2 hours.

Example 10: The method of any one of examples 7-9, wherein the soaking step is performed at a temperature from 18° C.-27° C.

Example 11: The method of any one of examples 7-10 that further includes the step of rinsing the graphite sheets with fresh solvent.

Example 12: The method of example 11 that further includes the step of drying the graphite sheets after the fresh solvent rinse.

Example 13: The method of any one of examples 7-12 that further comprises the step of measuring the mass of each graphite sheet.

Example 14: The method of any one of examples 7-13 that further includes the step of calculating the mass percentages of extractables for each graphite sheet.

Example 15: The method of example 14, wherein the mass percentage of extractables is calculated by subtracting the weight of the graphite sheets after drying, from the weight of the graphite sheets before drying.

Example 16: The method of any one of examples 7-15, wherein a step of GC-MS or GC-FID is performed on the remaining solvent to determine leachable monomers and/or contaminants in the remaining solvent.

Some further, non-limiting examples of this disclosure are as follows:

Example 1: A method for forming an impregnated graphite sheet configured for use in a hydrogen (H₂) fuel cell, the method comprising the steps of:
(a) impregnating a sheet of graphite with sealant;
(b) heating the graphite sheet to cure the sealant;
(c) adding a solvent to the cured graphite sheet; and
(d) determining the final mass of the cured sealant remained in the graphite sheet.

Example 2: The method of example 1, wherein the solvent is DCM/MeOH.

Example 3: The method of example 2, wherein the solvent is DCM/MeOH in a weight percentage of 90:10.

Example 4: The method of any one of examples 1-3, wherein the graphite sheet is immersed in the sealant during impregnation.

Example 5: The method of example 4, wherein the graphite sheet is immersed in the sealant for 3-30 min.

Example 6: The method of example 4, wherein the graphite sheet is cured for 3-120 min at 90° C.-125° C. at atmospheric pressure and higher.

Example 7: The method of any one of examples 1-6, wherein the cured impregnated graphite sheet is immersed in the solvent for 2 hours.

Example 8: The method of any one of examples 1-7 that further includes the step of measuring the percentage of extractables of the cured sealant in the graphite sheet.

Example 9: The method of example 8, wherein the step of measuring the percentage of extractables includes the step of measuring mass difference of the graphite sheet before soaking in solvent versus after removal from the solvent and being dried.

Example 10: The method of any one of examples 1-9, wherein the amount and component of extractables are determined by a GC-MS or GC-FID of the remaining mixture in the solvent.

Example 11: The method of any one of examples 1-10, wherein the sealant comprises a curing profile.

Example 12: The method of example 11, wherein the curing profile of the sealant is measured by a differential scanning calorimetry (DSC) tool.

Example 13: The method of any one of examples 11-12, wherein the curing profile is used to elucidate exothermic effect during curing.

Example 14: The method of example 12-13, wherein the DSC tool measures the heat released during the curing reactions.

Example 15: The method of any one of examples 1-14 that further includes the step of adding sealant into a pan.

Example 16: The method of example 15 that further includes the step of placing a graphite plate in a bottom of the pan.

Example 17: The method of example 16, wherein the graphite plate is either embossed or is a flat blank.

Example 18: The method of any one of examples 16-17, wherein the graphite plate contains openings.

Example 19: The method of any one of examples 15-18 that further includes the step of curing the sealant inside of the pan.

Example 20: The method of any one of examples 15-19 that further includes the step of loading the pan into a DSC chamber.

Example 21: The method of example 20, wherein the temperature inside of the DSC chamber is maintained at 35° C.

Example 22: The method of example 21, wherein the temperature inside of the DSC chamber is maintained at 35° C. for 1 minute.

Example 23: The method of example 22, wherein after 1 minute, the temperature inside of the DSC chamber is raised to 190° C.

Example 24: The method of example 23, wherein the temperature is raised at a rate of 10° C./min.

Example 25: The method of any one of examples 1-24 that further includes the step of conducting a gel time test configured to determine whether the resin is curing within the proper time.

Example 26: The method of example 25, wherein if the gel time is too long, the method is adjusted to add more activator to the resin.

Example 27: The method of example 26, wherein the step of conducting the gel time test comprises the steps of (a) placing a metal wire inside of a culture tube, (b) placing resin inside of the culture tube, and (c) placing the culture tube in a heat block maintained at 90° C.+/−1° C., and wherein the resin level in the tube is beneath the surface of the water bath. (d) recording the time sealant gels up

Example 28: The method of any one of examples 15-27, wherein the target cure time of the sealant is from 2-6 min.

Example 29: The method of any one of examples 1-28, wherein the graphite part is a graphite plate.

Example 30: The method of example 1, wherein the sealant is one or more, or a mixture, of ethoxylated monomers.

Example 31: The method of any one of examples 1-30, wherein the sealant comprises a methacrylate-based monomer.

Example 32: The method of any of examples 1-31, wherein the sealant has a viscosity at 22° C. of 8-20 centipoise (cP).

Example 33: The method of any one of examples 1-32, wherein the sealant includes a trifunctional monomer.

Example 34: A graphite plate impregnated with any of the sealants of examples 1-33.

Example 35: The graphite plate of example 34, wherein the sealant has been cured.

Example 36: The graphite plate of example 35, wherein the Tg of the cured graphite plate is greater than 120° C.

Example 37: The graphite plate of any one of examples 34-36, wherein the void fill of the cured graphite plate is greater than 90% or greater than 95%.

Example 38: The graphite plate of any one of examples 34-37, wherein the hydrophobicity of the graphite plate is determined by the water contact angle on the flat surfaces, greater than 105°.

Example 39: The graphite plate of any one of examples 34-38, wherein the extractables on the cured graphite sheet are less than 10% of the weight of the cured graphite plate.

Example 40: The graphite plate of any one of examples 34-39, wherein the time to cure the sealant is about 100 minutes, or about 10 minutes to about 45 minutes when immersed in water having a temperature of 80° C.-95° C.

Example 41: The method of any one of examples 1-33, wherein a vacuum is applied to the graphite plate while the graphite plate is being immersed in the sealant.

Example 42: The method of any one of claims 1-33 or 41, wherein the graphite plate is pressurized after being immersed in the sealant.

Having thus described some embodiments of the invention, other variations and embodiments that do not depart from the spirit of the invention will become apparent to those skilled in the art. The scope of the present invention is thus not limited to any particular embodiment but is instead set forth in the appended claims and the legal equivalents thereof. Unless expressly stated in the written description or examples, the steps of any method recited in the claims may be performed in any order capable of yielding the desired result.

What is claimed is:

1. A sealant configured to saturate and seal a graphite plate for use in a hydrogen (H₂) fuel cell, wherein the sealant comprises one or more ethoxylated [meth]acrylate monomers.

2. The sealant of claim 1 that comprises 70-95% by weight of triethylene glycol dimethacrylate monomer.

3. The sealant of claim 1 that comprises a [meth]acrylate-based monomer.

4. The sealant of claim 1, that includes a trifunctional monomer.

5. The sealant of claim 1, wherein the sealant has a viscosity at 22° C. from 8-20 centipoise (cP).

6. The sealant of claim 1, wherein the sealant is configured to be washed with water to remove it from the graphite plate surface prior to curing.

7. The sealant of claim 1 that has a cured hardness of up to 90 Shore D.

8. The sealant of claim 1, wherein the extractables in a cured graphite plate impregnated with the sealant are <3% by weight.

9. The sealant of claim 1 that provides a flexural strength of impregnated graphite plates at 95° C. of a <30% drop from RT strength.

10. The sealant of claim 1 that does not include a surfactant.

11. The sealant of claim 1 that can be cured by (a) E-beam radiation or, (b) heating.

12. The sealant of claim 1 that is further includes a radical initiator and that is configured to be cured by heating.

13. The sealant of claim 12 that has a cure profile of <100 minutes at a temperature of <100° C.

14. The sealant of claim 13, wherein the thermal cure profile is generated at atmospheric pressure.

15. The sealant of claim 1 that has a gel time in a 90° C. water bath of from 1.5 minutes to 3 minutes.

16. The sealant of claim 1 that has an activated resin stability of no curing up to 1 week at 40° C.

17. The sealant of claim 12 that is configured to cure in 10 minutes or less, or less than 45 minutes, after being impregnated in a graphite sheet and the graphite sheet is immersed in water at a temperature of 80° C.-95° C.

18. The sealant of claim 17, wherein the cure time is determined by a solvent extraction test.

19. The sealant of claim 1 that comprises a plurality of ethoxylated [meth] acrylate monomers.

20. The sealant of claim 12 that includes 0.15%-0.35% by weight of radical initiator.
